(19) United States
(12) Patent Application Publication
(10) Pub. No.: US 2026/0088231 A1
(43) Pub. Date: Mar. 26, 2026

(54) ELECTRONIC COMPONENT

(71) Applicant: TDK CORPORATION, Tokyo (JP)

(72) Inventors: Hsing-Wen YEH, Tokyo (JP); Kosuke TAKANO, Tokyo (JP); Momoyo SASAKI, Tokyo (JP)

(73) Assignee: TDK CORPORATION, Tokyo (JP)

(21) Appl. No.: 19/340,220

(22) Filed: Sep. 25, 2025

(30) Foreign Application Priority Data
Sep. 25, 2024 (JP) 2024-166538
Sep. 22, 2025 (JP) 2025-157486

(51) Int. Cl. H01G 4/30; H01G 4/12

(52) U.S. Cl. CPC H01G 4/30; H01G 4/1227; H01G 4/1236

(57) ABSTRACT

An electronic component includes an element body having internal electrode layers and dielectric layers that are alternately laminated. The dielectric layers contain main-phase grains and segregated particles. The main-phase grains contain a main component of the dielectric layers. The segregated particles contain Ba, Si, Ti, and O. The segregated particles are present at an occurrence rate in the range of 50 to 90%. A ratio of the main-phase grains in the form of complete solid solutions containing RE is 70% or more of the main-phase grains. The segregated particles do not substantially contain RE, and the RE represents at least one of rare earth elements.

The present application claims a priority based on Japanese Patent Applications No. 2024-166538 filed on Sep. 25, 2024, and No. 2025-157486 filed on Sep. 22, 2025, and incorporates them into the present specification by reference to those disclosures in their entirety.

### BACKGROUND OF THE INVENTION

The present invention relates to an electronic component.

Multilayer ceramic capacitors, which are a common type of electronic component, have been reduced in size and increased in capacitance, and are therefore required to have an excellent service life and a further improved permittivity.

For example, Patent Document 1 (Japanese Unexamined Patent Application Laid-Open No. 2021-184447) discloses a capacitor configured to include the following dielectric layers and laminate in order to improve high-temperature load life. The dielectric layers include crystal grains containing titanate. The laminate includes a crystal phase of a BaTiSiO compound, which contains a secondary phase composed of a rare earth element-containing compound.

However, Patent Document 1 is not directed to a multilayer ceramic capacitor having a high permittivity.

### BRIEF SUMMARY OF THE INVENTION

The present invention has been achieved under such circumstances, and an object of the present invention is to provide an electronic component exhibiting an excellent service life and a high permittivity.

To achieve the above-described object, an electronic component according to one embodiment of the present invention includes:
an element body including internal electrode layers and dielectric layers substantially parallel to a plane including a first axis and a second axis and alternately laminated along a third axis,
wherein
the element body has a pair of end surfaces opposing each other in the first axis direction, each of the end surfaces is provided with an external electrode electrically connected to the internal electrode layers,
the dielectric layers contain main-phase grains and segregated particles,
the main-phase grains contain a main component of the dielectric layers,
the main component is represented by a formula ABO₃, in which the symbol A represents at least one selected from the group consisting of Ba, Ca, and Sr, and the symbol B represents at least one selected from the group consisting of Ti and Zr,
the segregated particles contain Ba, Si, Ti, and O,
the segregated particles are present at an occurrence rate in the range of 50 to 90%,
the occurrence rate of the segregated particles is defined as a ratio of the number of fields of view satisfying conditions
(i) eight or more of the segregated particles are present, and
(ii) at least one segregated particle is located at a triple junction, among a predetermined number of fields of view in which four or more of the dielectric layers are observed,
in a cross section parallel to a plane including the first axis and the second axis of an effective region,
the effective region is a region where the dielectric layers are laminated between pairs of internal electrode layers having different polarities, the fields of view to be observed are approximately uniformly distributed along the first axis direction, the second axis direction, and the third axis direction of the effective region,
a ratio of the main-phase grains in the form of complete solid solutions containing RE is 70% or more of the main-phase grains,
the segregated particles do not substantially contain RE, and
the RE represents at least one of rare earth elements.

Thus, the electronic component described above exhibits excellent long service life and high permittivity.

At least one of the segregated particles may be present within one of the main-phase grains.

The content of Ba in terms of BaO in the segregated particles may be 50 parts by mol or more, assuming that the total content of Ba in terms of BaO, Si in terms of SiO₂, Ti in terms of TiO₂, and RE in terms of RE₂O₃ in the segregated particles is defined as 100 parts by mol.

The content of Si in terms of SiO₂ in the segregated particles may be 10 parts by mol or less, assuming that the total content of Ba in terms of BaO, Si in terms of SiO₂, Ti in terms of TiO₂, and RE in terms of RE₂O₃ in the segregated particles is defined as 100 parts by mol.

The content of Ti in terms of TiO₂ in the segregated particles may be 40 parts by mol or less, assuming that the total content of Ba in terms of BaO, Si in terms of SiO₂, Ti in terms of TiO₂, and RE in terms of RE₂O₃ in the segregated particles is defined as 100 parts by mol.

The average particle size of the segregated particles may be 50 nm or more.

The average particle size of the segregated particles may be 33% or less of the average grain size of the main-phase grains.

### BRIEF DESCRIPTION OF THE DRAWING(S)

FIG. 1A is a schematic cross-sectional view of a multilayer ceramic capacitor according to an embodiment of the present invention;

FIG. 1B is a schematic cross-sectional view of the multilayer ceramic capacitor along the line IB-IB in FIG. 1A; and

FIG. 2 is an enlarged view of a main part in FIG. 1A.

### DETAILED DESCRIPTION OF THE INVENTION

Hereinafter, the present invention will be described with reference to an embodiment shown in the figures.

### (Multilayer Ceramic Capacitor)

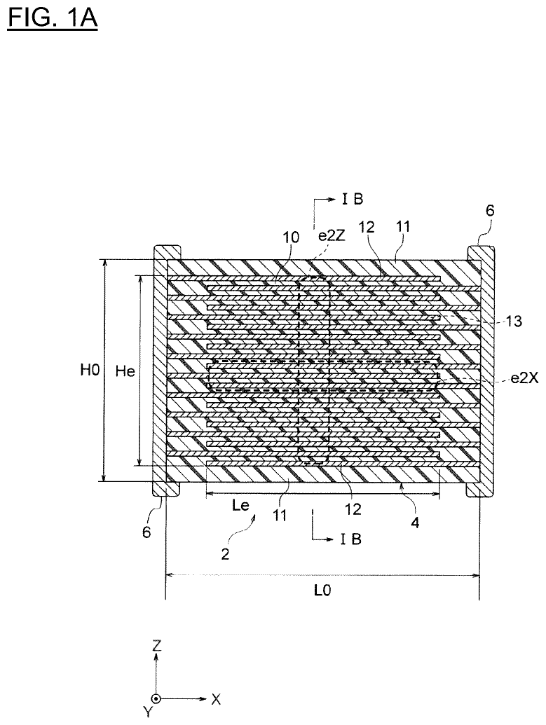

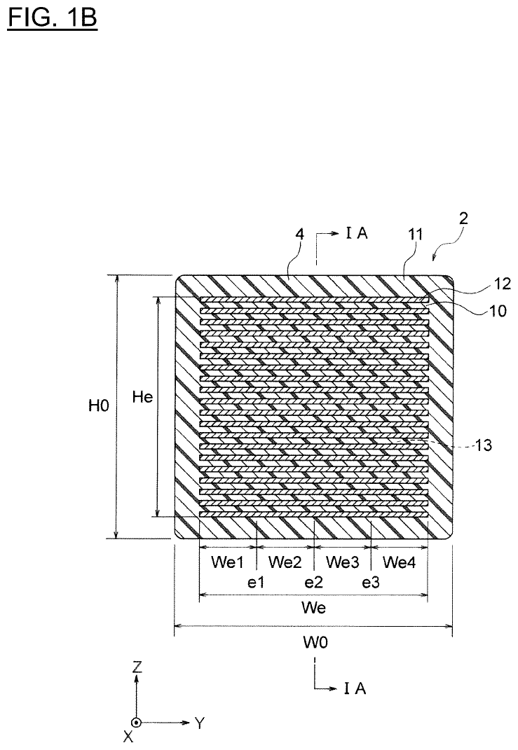

FIGS. 1A and 1B show a multilayer ceramic capacitor 2 as an example of an electronic component. FIG. 1B is a cross-sectional view of the multilayer ceramic capacitor 2 along the line IB-IB in FIG. 1A.

The multilayer ceramic capacitor 2 includes an element body 4 having inner dielectric layers 10 and internal electrode layers 12. These layers are substantially parallel to a plane including the X-axis and the Y-axis, and are alternately laminated along the Z-axis direction.

Herein, the term “substantially parallel” means that most parts are parallel, although some parts may deviate within an acceptable range. The internal electrode layers 12 and the inner dielectric layers 10 may each be slightly uneven or inclined.

The internal electrode layers 12 are laminated in such a manner that the end surfaces thereof are alternately exposed at two opposing end surfaces of the element body 4.

An external electrode 6 is provided on each of a pair of end surfaces, which oppose each other in the X-axis direction, of the element body 4, and each external electrode 6 is electrically connected to the internal electrode layers 12. That is, the pair of external electrodes 6 is formed at both ends of the element body 4 along the X-axis direction and is connected to the exposed end surfaces of the alternately arranged internal electrode layers 12, thereby forming a capacitor circuit. Herein, the area indicated by the reference symbols “He” in FIGS. 1A and 1B, “Le” in FIG. 1A, and “We” in FIG. 1B is a region in which the inner dielectric layers 10 are laminated between pairs of internal electrode layers 12 having different polarities, and this region is an effective region 13 of the capacitor circuit. Hereinafter, this region may simply be referred to as “effective region 13”.

The shape of the element body 4 is not specifically limited, but is normally a rectangular parallelepiped as shown in FIGS. 1A and 1B. In addition, the dimensions thereof are not specifically limited.

### (Dielectric Layers)

In the present embodiment, the “inner dielectric layers 10” and “outer dielectric layers 11” may be collectively referred to as “dielectric layers”.

The thickness per layer (interlayer thickness) of the inner dielectric layers 10 is not specifically limited and can be appropriately determined according to desired characteristics and applications. Normally, the interlayer thickness may be 20 μm or less, 10 μm or less, or 5 μm or less. Also, the number of laminated inner dielectric layers 10 is not specifically limited and may be, for example, 10 or more, 100 or more, or 200 or more.

The thickness per layer (interlayer thickness) of the outer dielectric layers 11 is not specifically limited and can be, for example, equal to the interlayer thickness of the inner dielectric layers 10. The number of laminated outer dielectric layers 11 is not specifically limited and may be, for example, 5 or more, or 20 or more.

In the present embodiment, the main component of the dielectric layers is contained in main-phase grains 10a. The main component of the dielectric layers is represented by a formula ABO₃ and may be a compound having a perovskite crystal structure. Herein, the symbol A represents an A-site element and refers to at least one selected from the group consisting of Ba, Ca, and Sr, and the symbol B represents a B-site element and refers to at least one selected from the group consisting of Ti and Zr.

The main component of the dielectric layers refers to a component that accounts for 80 parts by mass or more, preferably 90 parts by mass or more, per 100 parts by mass of the dielectric layers.

A specific example of the compound represented by the formula ABO₃ is {(Ba_{1-x-y}CaₓSr_{y})O}ᵤ(Ti_{1-z}Zr_{z})ᵥO₂. The symbols u, v, x, y, and z can take values within appropriate ranges, and are preferably within the following ranges. In the above formula, u/v is preferably 1.000≤u/v≤1.010, and more preferably 1.000≤u/v≤1.008.

In the above formula, x is preferably 0≤x≤0.1, and more preferably 0≤x≤0.05. Setting x within this range improves relative permittivity. In the present embodiment, Ca is not necessarily contained. That is, x may be zero.

In the above formula, y is preferably 0≤y≤0.1, and more preferably 0≤y≤0.05. Setting y within this improves relative permittivity. In the present embodiment, Sr is not necessarily contained. That is, y may be zero.

In the above formula, z is preferably 0≤z≤0.3, and more preferably 0≤z≤0.15. Setting z within this range improves relative permittivity. In the present embodiment, Zr is not necessarily contained. That is, z may be zero.

The main component of the dielectric layers according to the present embodiment is preferably barium titanate. In other words, it is preferable to set x=y=z=0.

The dielectric layers according to the present embodiment may contain Ba, Si, Mg, Mn, and one or more rare earth elements as subcomponents. Hereinafter, the “rare earth element” may be referred to as “RE”. Examples of RE include Sc, Y, La, Ce, Pr, Nd, Pm, Sm, Eu, Gd, Tb, Dy, Ho, Er, Tm, Yb, and Lu.

RE having a larger ionic radius is more easily incorporated into the main-phase grains 10a. Thus, solid solutions are more readily formed, thereby improving the complete solid solubility of RE. Details of the main-phase grains 10a and the complete solid solubility of RE will be described later.

The subcomponents of the dielectric layers may exist in a solid solution state within the main-phase grains 10a, or may be present as components for forming segregated particles 10b, which will be described later.

Based on 100 parts by mol of the main component contained in the dielectric layers, the amount of Ba contained as a subcomponent in the dielectric layers is preferably 1.5 to 4.5 parts by mol, and more preferably 1.5 to 3.0 parts by mol.

Based on 100 parts by mol of the main component contained in the dielectric layers, the amount of Si contained as a subcomponent in the dielectric layers is preferably 0.25 to 0.75 parts by mol, and more preferably 0.5 to 0.75 parts by mol.

In addition, based on 100 parts by mol of the main component contained in the dielectric layers, the total amount of Ba and Si contained as subcomponents in the dielectric layers is preferably 1.75 to 5.25 parts by mol, and more preferably 1.75 to 3.5 parts by mol.

By setting the total amount of Ba and Si contained as subcomponents in the dielectric layers, within the above-described range, the occurrence rate of the segregated particles 10b (described later) can be easily controlled within a desired range. Moreover, the molar ratio of Ba to Si contained in the dielectric layers (Ba/Si molar ratio) is preferably 3 to 6.

In the case in which the molar ratio of Ba to Si, contained as subcomponents in the dielectric layers, is within the above-described range, RE tends to be easily incorporated into the main-phase grains 10a (described later), resulting in the formation of solid solutions, and RE is less likely to be present in the segregated particles 10b (described later), compared with a case in which the molar ratio falls below the range.

Additionally, in the case in which the molar ratio of Ba to Si, contained as subcomponents in the dielectric layers, is within the above-described range, the occurrence rate of the segregated particles 10b (described later) can be controlled at a low level, compared with a case in which the molar ratio exceeds the range.

Based on 100 parts by mol of the main component contained in the dielectric layers, the amount of Mg contained as a subcomponent in the dielectric layers is preferably 0.05 parts by mol or more but less than 1 parts by mol, and more preferably 0.15 to 0.5 parts by mol.

In the case in which the amount of Mg, contained as a subcomponent in the dielectric layers, is within the above-described range, it is possible to reduce generation of the main-phase grains 10a, which have a core-shell structure, resulting in improvement in the complete solid solubility of RE (described later), compared with a case in which the amount of Mg exceeds the range.

Based on 100 parts by mol of the main component contained in the dielectric layers, the amount of Mn contained as a subcomponent in the dielectric layers is preferably 0.01 to 0.5 parts by mol, and more preferably 0.1 to 0.2 parts by mol.

Based on 100 parts by mol of the main component contained in the dielectric layers, the amount of RE contained as a subcomponent in the dielectric layers is preferably 0.01 to 0.5 parts by mol, and more preferably 0.01 to 0.2 parts by mol.

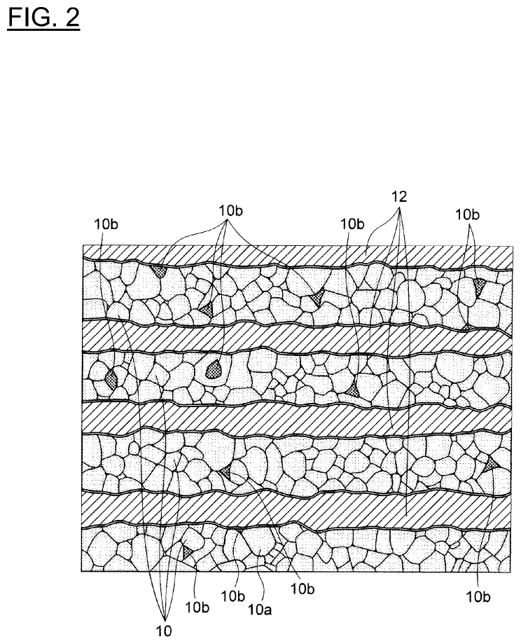

FIG. 2 is an enlarged view of a main part, showing the effective part 13 of the element body 4 in FIG. 1A.

As shown in FIG. 2, the dielectric layers (the inner dielectric layers 10 and the outer dielectric layers 11) according to the present embodiment include main-phase grains (dielectric grains) 10a. An interface between one main-phase grain 10a and another main-phase grain 10a is a grain boundary. The dielectric layers also include segregated particles 10b, particularly at triple junctions, in addition to the main-phase grains 10a. The segregated particles 10b may be present within the main-phase grains 10a.

The following describes a method for observing a microscopic structure at a cross section of the effective part 13 shown in FIG. 2. First, an element body 4 is polished after firing so as to expose its central portion, and the polished surface is ion-milled to obtain a cross-sectional specimen. Then, the cross-sectional specimen is thinned to a thickness of approximately 100 nm using a focused ion beam (FIB), and an analytical thin specimen is thus obtained.

The cross-sectional surfaces of the specimens thus obtained are observed using a scanning electron microscope (SEM), a scanning transmission electron microscope (STEM), or the like. Specifically, a SEM is used to observe the cross-sectional surface of the ion-milled cross-sectional specimen, whereas a STEM is used to observe the cross-sectional surface of the analytical thin specimen.

When observing a backscattered electron image from SEM and a high-angle annular dark-field (HAADF) image from STEM, high-density regions tend to appear as bright areas. In view of this, darker areas can be identified as main-phase grains 10a, whereas brighter areas can be identified as segregated particles 10b. In addition, areas with higher contrast than YAG (Yttrium Aluminum Garnet) can also be identified as segregated particles 10b. The backscattered electron detector may be a semiconductor backscattered electron detector or a YAG backscattered electron detector.

When observing the analytical thin specimen with an energy-dispersive X-ray spectrometer attached to a STEM (STEM-EDX), areas where significantly uneven distribution of Si is detected can also be identified as the segregated particles 10b.

Moreover, the analytical thin specimen may be spot-analyzed using STEM-EDX, whereby compositions of the main-phase grains 10a and the segregated particles 10b can be calculated.

In the present embodiment, the occurrence rate of the segregated particles 10b ranges from 50% to 90%, preferably from 70% to 90%. Herein, the occurrence rate of the segregated particles 10b is calculated by the following method.

The occurrence rate of the segregated particles 10b is defined as the ratio of the number of fields of view that satisfy the following conditions, among a predetermined number of fields of view in which four or more inner dielectric layers 10 are observed, in a cross section parallel to a plane including the X-axis and the Z-axis (a cross section including the X-axis and the Z-axis) of the effective region 13. The conditions are that eight or more segregated particles 10b are present, and that at least one segregated particle 10b is located at a triple junction. The fields of view to be observed are approximately uniformly distributed along the X-axis direction, the Y-axis direction, and the Z-axis direction of the effective region 13.

Herein, the “predetermined number of fields of view” is preferably 50 or more, and more preferably 60 or more.

The fields of view to be observed are approximately uniformly distributed along the X-axis direction, the Y-axis direction, and the Z-axis direction of the effective region 13. This is because the segregated particles 10b are distributed and unevenly present throughout the entire effective region 13 in the present embodiment.

Thus, in the present embodiment, even when the fields of view to be observed are selected from a wide area of the effective region 13, the occurrence rate of the segregated particles 10b ranges from 50% to 90%. The method for selecting the fields of view to be observed is described below with reference to FIGS. 1A and 1B, for example.

FIG. 1B shows the width W0 in the Y-axis direction of the element body 4. The symbol We denotes the width in the Y-axis direction of the effective region 13. The symbols e1, e2, and e3 denote imaginary lines that divide the width We into four equal parts. The widths We1, We2, We3, and We4, defined by these lines, satisfy the relationship We1=We2=We3=We4.

The Z-X cross section of the multilayer ceramic capacitor 2 taken along the line e1 is referred to as the e1-Z-X cross section. The Z-X cross section of the multilayer ceramic capacitor 2 taken along the line e2 is referred to as the e2-Z-X cross section. The Z-X cross section of the multilayer ceramic capacitor 2 taken along the line e3 is referred to as the e3-Z-X cross section.

FIG. 1A is a schematic cross-sectional view of the multilayer ceramic capacitor 2 along the line IA-IA in FIG. 1B. FIG. 1A also corresponds to the e2-Z-X cross section.

FIG. 1A shows the height H0 in the Z-axis direction of the element body 4. The height He denotes the height in the Z-axis direction of the effective region 13. FIG. 1A also shows the length L0 in the X-axis direction of the element body 4. The length Le denotes the length in the X-axis direction of the effective region 13.

In the present embodiment, an imaginary region in the central part of the X-axis direction and extending along the height He in the Z-axis direction of the effective region 13 is referred to as the e2Z region. In addition, an imaginary region in the central part of the Z-axis direction and extending along the length Le in the X-axis direction of the effective region 13 is referred to as the e2X region.

In the present embodiment, ten or more fields of view are observed along the Z-axis direction in the e2Z region. In this case, some of the fields of view are set so as to include the vicinity of the end in the Z-axis direction of the effective region 13. Preferably, the fields of view are distributed at approximately equal intervals within the e2Z region.

Ten or more fields of view are also observed along the X-axis direction in the e2X region. In this case, some of the fields of view are set so as to include the vicinity of the end in the X-axis direction of the effective region 13. Preferably, the fields of view are distributed at approximately equal intervals within the e2X region.

Although the e2Z region and the e2X region intersect, the fields of view selected from the e2Z region do not overlap with those selected from the e2X region.

In this manner, 20 or more fields of view are observed in the e2-Z-X cross section. Moreover, 20 or more fields of view are selected and observed in each of the e1-Z-X cross section and the e3-Z-X cross section, in a manner similar to that used for the e2-Z-X cross section. Thus, observations are made in a total of 60 or more fields of view per multilayer ceramic capacitor 2.

In the present embodiment, observation is performed over a wide area of the effective region 13. Thus, the results of observations made in the fields of view selected in this manner are regarded as results representing observation of the entire effective region 13, rather than just a part of it. As described above, in the present embodiment, the occurrence rate of the segregated particles 10b, which ranges from 50% to 90%, is also derived from observations made in the fields of view selected across the entire effective region 13.

In the present embodiment, 70% or more of the main-phase grains 10a are in the form of complete solid solutions containing RE. The ratio of the main-phase grains 10a in the form of complete solid solutions containing RE is hereinafter referred to as the “complete solid solubility of RE”. In the present embodiment, the complete solid solubility of RE is preferably 70% or more, and more preferably 80% or more. In the case in which the complete solid solubility of RE is high, the relative permittivity tends to increase.

The complete solid solubility of RE can be controlled, for example, by adjusting the amount of Mg or by selecting an RE element having a different ionic radius.

Specifically, the amount of Mg contained in the powder for the dielectric layers is reduced so that RE can be diffused into the main-phase grains 10a during firing. This increases the complete solid solubility of RE, thereby improving the relative permittivity. In addition, diffusion of RE into the main-phase grains 10a during firing tends to cause grain growth of the main-phase grains 10a.

RE having a larger ionic radius is more easily incorporated into the main-phase grains 10a. Thus, solid solutions are more readily formed, and the complete solid solubility of RE tends to increase.

Examples of the main-phase grains 10a which are not in the form of complete solid solutions containing RE may include grains having a core-shell structure and grains in which RE is not incorporated in the form of solid solution.

Whether the main-phase grain 10a is in the form of a complete solid solution containing RE can be determined by the following method.

First, the inner dielectric layers 10 in an analytical thin specimen of the effective region 13 are observed by STEM. Among the main-phase grains 10a, one in which the content of RE at the center exceeds 0.1 mol % is determined to be the main-phase grain 10a in the form of a complete solid solution containing RE. This determination is performed in the same manner on ten or more arbitrarily selected main-phase grains 10a. The ratio of the main-phase grains 10a in the form of complete solid solutions containing RE, that is, the complete solid solubility of RE, is then calculated.

The total content of Ba in terms of BaO, Si in terms of SiO₂, Ti in terms of TiO₂, and RE in terms of RE₂O₃ in the segregated particle 10b is defined as 100 parts by mol. Based on this, the content of Ba in terms of BaO in the segregated particle 10b is preferably 50 parts by mol or more, more preferably 50 to 70 parts by mol, and further preferably 55 to 65 parts by mol.

The total content of Ba in terms of BaO, Si in terms of SiO₂, Ti in terms of TiO₂, and RE in terms of RE₂O₃ in the segregated particle 10b is defined as 100 parts by mol. Based on this, the content of Si in terms of SiO₂ in the segregated particle 10b is preferably 10 parts by mol or less, more preferably 3 to 9 parts by mol, and further preferably 6 to 9 parts by mol.

The total content of Ba in terms of BaO, Si in terms of SiO₂, Ti in terms of TiO₂, and RE in terms of RE₂O₃ in the segregated particle 10b is defined as 100 parts by mol. Based on this, the content of Ti in terms of TiO₂ in the segregated particle 10b is preferably 40 parts by mol or less, more preferably 20 to 40 parts by mol, and further preferably 25 to 35 parts by mol.

The segregated particle 10b does not substantially contain RE. The total content of Ba in terms of BaO, Si in terms of SiO₂, Ti in terms of TiO₂, and RE in terms of RE₂O₃ in the segregated particle 10b is defined as 100 parts by mol. Based on this, the content of RE in terms of RE₂O₃ in the segregated particle 10b is preferably 0.1 parts by mol or less.

The segregated particle 10b may further contain elements other than those described above. The total content of Ba in terms of BaO, Si in terms of SiO₂, Ti in terms of TiO₂, and RE in terms of RE₂O₃ in the segregated particle 10b is defined as 100 parts by mol. Based on this, the total content of the elements other than those described above in terms of oxides in the segregated particle 10b is preferably 0.5 parts by mol or less. Examples of the elements other than those described above in the segregated particles 10b may include elements constituting the main component of the dielectric layers, such as Sr or Ca.

The average grain size of the main-phase grains 10a in the present embodiment varies with the thickness of the dielectric layers, and it is preferably 0.2 to 1.0 μm, and more preferably 0.4 to 0.9 μm.

The average grain size of the main-phase grains 10a can be measured, for example, by the following method.

The cross-sectional specimen prepared as described above is observed using SEM, and SEM images are obtained at a magnification that allows observation of 50 or more main-phase grains 10a. After a number of SEM images are obtained, the area of each of 400 or more main-phase grains 10a is calculated. Then, an average value is calculated and is then multiplied by 1.27 to determine the average grain size of the main-phase grains 10a. That is, in the present embodiment, the average grain size of the main-phase grains 10a is calculated as the average of sphere-equivalent diameters.

The average particle size of the segregated particles 10b of the dielectric composition in the present embodiment is preferably 50 nm or more, and more preferably 100 nm or more and 300 nm or less. In addition, the average particle size of the segregated particles 10b is preferably 33% or less of the average grain size of the main-phase grains 10a, and more preferably 15% to 30% of that size.

The cross-sectional specimen prepared as described above is observed using SEM, and SEM images are obtained at a magnification that allows observation of 50 or more main-phase grains 10a. After a number of SEM images are obtained, each of the area of 20 or more segregated particles 10b is calculated. Then, an average value is calculated and is then multiplied by 1.27 to determine the average particle size of the segregated particles 10b. That is, in the present embodiment, the average particle size of the segregated particles 10b is calculated as the average of sphere-equivalent diameters.

### (Internal Electrode Layers)

The conductive material that is contained in the internal electrode layers 12 is not specifically limited. However, since the material constituting the inner dielectric layers 10 exhibits resistance to reduction, a relatively inexpensive base metal can be used. In cases in which base metal is employed as the conductive material, Ni or Ni alloy is preferably used. An alloy of Ni and one or more elements selected from the group consisting of Mn, Cr, Co, and Al, is preferably used as the Ni alloy. The content of Ni in the alloy is preferably 95 mass % or more. Minor components such as P may be contained in Ni or a Ni alloy in a total amount of about 0.1 mass % or less. The thickness of the internal electrode layer 12 may be appropriately adjusted depending on the application and is not specifically limited. Normally, the thickness is 0.1 to 3.0 μm and is preferably approximately 0.5 to 2.0 μm.

### (External Electrodes)

The conductive material contained in the external electrodes 6 is not specifically limited, but inexpensive materials such as Ni, Cu, or an alloy thereof can be used in the present embodiment. The thickness of the external electrode 6 may be suitably determined depending on the application and is normally preferably approximately 10 to 50 μm.

### (Method of Manufacturing Multilayer Ceramic Capacitor)

The multilayer ceramic capacitor 2 in the present embodiment is manufactured in a manner similar to that used for existing multilayer ceramic capacitors. That is, a green chip is prepared by an ordinary printing method or sheet-forming method using paste. After the green chip is fired, the external electrodes 6 are printed or transferred onto it, and they are fired. Hereinafter, the manufacturing method will be specifically described.

First, a dielectric raw material (dielectric composition powder) is prepared and is made into a paste (dielectric layer paste) for forming the inner dielectric layers 10.

### (Dielectric Raw Material)

A raw material having ABO₃ composition is first prepared as the main component of the dielectric raw material. ABO₃ is preferably barium titanate, which is represented by a formula BaᵤTiᵥO₃.

The ABO₃ raw material can be one that is produced by various methods, such as various liquid-phase methods (e.g., the oxalate method, the hydrothermal synthesis method, the alkoxide method, and the sol-gel method), in addition to generally known solid-phase methods.

In the case of using barium titanate, which is represented by the formula BaᵤTiᵥO₃, as the ABO₃ raw material, the u/v ratio is preferably in the range 1.000≤u/v≤1.005. Setting the u/v ratio within this range facilitates appropriate control of grain growth during firing. Thus, the multilayer ceramic capacitor 2 that is manufactured using the dielectric raw material exhibits improved temperature characteristics and extended high-temperature load life.

The average particle size of the ABO₃ raw material is preferably 0.10 to 0.30 μm, and more preferably 0.10 to 0.17 μm. Setting the average particle size of ABO₃ to be used within this range facilitates appropriate control of sintering and of particle growth of the segregated particles 10b. Thus, the multilayer ceramic capacitor 2 that is manufactured using the dielectric raw material exhibits improved reliability and temperature characteristics.

As raw materials of the subcomponents, oxides of the components described above, their mixtures, and composite oxides thereof can be used. It is also possible to employ a mixture of various compounds which, upon firing, form the above-mentioned oxides or composite oxides. Examples of the various compounds include carbonates, oxalates, nitrates, hydroxides, and organometallic compounds.

The raw materials of the main component and the subcomponent may be simply mixed to obtain a dielectric raw material. Alternatively, some portion of the raw material of the main component may be covered with the raw material of the subcomponent.

Specifically, powder particles of ABO₃ may be covered with powder particles of BaCO₃ and powder particles of SiO₂. The covering can be performed by a known method. For example, powders of BaCO₃ and SiO₂ may be dissolved to prepare respective solutions, which are then mixed with an ABO₃-dispersed slurry. Then, the mixture may be heat-treated so that surfaces of particles of ABO₃ are covered with particles of BaCO₃ and SiO₂.

### (Dielectric Layer Paste)

The dielectric layer paste may be an organic-based paint, which is obtained by kneading the dielectric raw material with an organic vehicle, or may be a water-based paint, which is obtained by kneading the dielectric raw material with an aqueous vehicle.

The organic vehicle is a binder dissolved in an organic solvent. The binder is not specifically limited and may be appropriately selected from various binders used in general organic vehicles, such as ethylcellulose or polyvinyl butyral. The organic solvent used is also not specifically limited and may be appropriately selected from various organic solvents, such as terpineol, butyl carbitol, acetone, or toluene, depending on the method employed, such as a printing method or a sheet-forming method.

The aqueous vehicle is one in which a water-soluble binder, a dispersant, or the like is dissolved or dispersed in water. The water-soluble binder to be used in the aqueous vehicle is not specifically limited and may be appropriately selected from various binders used in general aqueous vehicles, such as polyvinyl alcohol, cellulose, or water-soluble acrylic resin.

### (Internal Electrode Layer Paste)

An internal electrode layer paste is prepared by kneading the above-described organic vehicle with the above-described conductive material composed of various conductive metals, alloys, or the like, or with a precursor that becomes the above-described conductive material upon firing, such as various oxides, organometallic compounds, or resinates. The internal electrode layer paste may contain a co-firing material. The co-firing material is not specifically limited, but it preferably contains barium titanate.

### (External Electrode Paste)

An external electrode paste may be prepared in the same manner as described above in relation to the internal electrode layer paste.

The amount of the organic vehicle in each of the above-described pastes is not specifically limited and may be a typical amount. For example, the amount of binder may be approximately 1 to 10 mass %, and the amount of solvent may be approximately 10 to 50 mass %. If necessary, each of the pastes may contain additives selected from various inorganic or organic substances such as dispersants, plasticizers, dielectrics, and insulators. The total amount of them is preferably 10 mass % or less.

### (Printing and Laminating)

In the case in which a printing method is used, the dielectric layer paste and the internal electrode layer paste are printed onto a substrate made of PET or the like. These pastes are then alternately laminated on each other, cut into a predetermined shape, and peeled off from the substrate to obtain a green chip.

In the case in which a sheet-forming method is used, green sheets are formed using the dielectric layer paste, and internal electrode patterns are formed thereon by printing the internal electrode layer paste. Then, these sheets are laminated to obtain a green chip.

### (Binder Removal)

The conditions for binder removal are not specifically limited; however, it is preferable that the heating rate be 5 to 300° C./h, the holding temperature be 180 to 800° C., and the holding time at the set temperature be 0.5 to 48 hours. In addition, the atmosphere used during binder removal is preferably an air atmosphere or a reducing atmosphere.

### (Firing)

The green chip is fired after binder removal. The heating rate is preferably 10000 to 200000° C./h, and more preferably 12000 to 200000° C./h. The holding temperature during firing is preferably 1320° C. or lower, and more preferably, 1200 to 1300° C. The holding time during firing is preferably 0.01 to 20 hours, and more preferably 0.04 to 0.1 hours. Controlling the heating rate and the holding time within the above-described ranges facilitates sufficient solid solution of the subcomponents into the main-phase grains 10a, as well as control of the sizes of the segregated particles 10b within a desired range. Furthermore, spheroidization of the electrodes is prevented, while the dielectric compositions are easily densified, resulting in improved high-temperature load life. The cooling rate is not specifically limited, but it is preferably 50 to 1000° C./h.

The atmosphere during firing is preferably a reducing atmosphere. The atmospheric gas is not specifically limited. For example, a humidified gas mixture of N₂ and H₂ can be used.

The oxygen partial pressure during firing may be suitably set depending on the type of the conductive material in the internal electrode layer paste. For example, in a case in which a base metal, such as Ni or a Ni alloy, is used as the conductive material, the oxygen partial pressure in the firing atmosphere is preferably in the range of 10-14 to 10-10 MPa. Setting the oxygen partial pressure within this range enables prevention of oxidation of the internal electrode layers 12, while facilitating normal sintering of the conductive material therein.

### (Annealing)

The element body 4 is preferably subjected to an annealing treatment after being fired in a reducing atmosphere. Annealing is a treatment for reoxidizing the inner dielectric layers 10 and significantly increases their insulation resistance (IR), thereby improving high-temperature load life (as measured by insulation resistance; IR load life).

The atmosphere during annealing is not specifically limited, but the oxygen partial pressure is preferably in the range of 10⁻⁹ to 10⁻⁵ MPa. Setting the oxygen partial pressure within this range enables prevention of oxidation of the internal electrode layers 12, while facilitating reoxidation of the inner dielectric layer 10.

The holding temperature during annealing is not specifically limited; however, it is preferably 1100° C. or less, and particularly preferably in the range of 850 to 1090° C. Setting the holding temperature within this range facilitates sufficient oxidation of the inner dielectric layers 10. Moreover, oxidation of the internal electrode layers 12 and reaction between the internal electrode layers 12 and the inner dielectric layers 10 are prevented, whereby the multilayer ceramic capacitor 2 tends to exhibit excellent temperature characteristics, insulation resistance (IR), high-temperature load life, and capacitance.

In addition to the annealing conditions described above, the holding time at the set temperature is preferably in the range of 0 to 20 hours, and more preferably in the range of 2 to 4 hours. The cooling rate is preferably in the range of 50 to 1000° C./h, and more preferably in the range of 100 to 600° C./h. Additionally, the atmospheric gas during annealing is not specifically limited. For example, a humidified N₂ gas is preferably used.

In the binder removal, firing, and annealing described above, an N₂ gas, a mixed gas, or the like may be humidified, for example, using a humidifier. When the humidifier is used, the water temperature is preferably in the range of approximately 5 to 75° C.

The binder removal, firing, and annealing may be performed either continuously or independently as separate processes.

Main-phase grains, such as those containing barium titanate, exhibit higher relative permittivity as their grain size increases. In view of this, studies are under way to incorporate RE into the central regions of the main-phase grains to form complete solid solutions, thereby preventing formation of a core-shell structure and promoting grain growth. On the other hand, grain growth of the main-phase grains causes uneven distribution of the segregated particles, which tends to result in easy generation of short circuits, particularly in regions where the segregated particles are absent. As a result, the service life tends to decrease.

In consideration of this, the inventors of the present invention have found that RE can be incorporated into the central regions of the main-phase grains 10a to form complete solid solutions, while the segregated particles 10b are evenly distributed to such an extent as not to cause a decrease in relative permittivity. Thus, the present invention enables providing an electronic component exhibiting excellent long service life and high permittivity.

### Examples

Hereinafter, the present invention will be further described with reference to detailed examples. However, the present invention is not limited to these examples.

### <Sample No. 1>

A BaᵤTiᵥO₃ powder (u/v=1.004) was prepared as a raw material powder composed of barium titanate, which was used as a main component. The average particle size of the BaᵤTiᵥO₃ powder was 0.15 μm.

The BaᵤTiᵥO₃ powder was wet-mixed using a ball mill to break up agglomerates.

Then, BaCO₃ powder, SiO₂ powder, MgO powder, MnCO₃ powder, and RE₂O₃ powder were respectively prepared as subcomponents. The average particle sizes of the raw material powders used as the subcomponents were in the range of 0.1 to 0.3 μm.

All of the raw material powders used as the subcomponents were subjected to preliminary grinding.

Next, each of the raw material powders used as the subcomponents was weighed in an amount corresponding to the value shown in Table 1A, based on 100 parts by mol of barium titanate. Each of these powders was wet-mixed and ground in a ball mill for 20 hours, and then dried to obtain a dielectric raw material. In the later process, BaCO₃ and MnCO₃ were respectively converted into BaO and MnO during firing and were incorporated into the dielectric layers.

Thereafter, 100 parts by mass of the obtained dielectric raw material, 10 parts by mass of polyvinyl butyral resin, 5 parts by mass of dioctyl phthalate (DOP), and 100 parts by mass of alcohol were mixed using a ball mill and kneaded into a paste to obtain a dielectric layer paste. In the dielectric layer paste, DOP was used as a plasticizer, and alcohol was used as a solvent.

Separately from the dielectric layer paste described above, 44.6 parts by mass of Ni particles, 52 parts by mass of terpineol, 3 parts by mass of ethyl cellulose, and 0.4 parts by mass of benzotriazole were kneaded using a three-roll mill to obtain an internal electrode layer paste.

Then, the dielectric layer paste was used to form a green sheet on a PET film. The green sheet was formed so that its thickness would be 1.2 μm after drying.

Next, the internal electrode layer paste was used to print an electrode layer in a predetermined pattern on a green sheet. After the electrode layer was printed, the green sheet was peeled off from the PET film to prepare a green sheet having the electrode layer.

Multiple green sheets each having the electrode layer were then laminated and bonded under pressure to form a green laminate, which was then cut into a predetermined size to obtain a green chip.

Next, the obtained green chip was subjected to the binder removal, firing, and annealing under the following conditions to obtain a multilayer ceramic fired body (element body).

The binder removal conditions were as follows: the heating rate was 25° C./h, the holding temperature was 235° C., the holding time at the set temperature was 8 hours, and an air atmosphere was used.

The firing conditions were as follows: the heating rate was 13000° C./h, the holding temperature was 1300° C., the holding time at the set temperature was 0.04 hours, and the cooling rate was 13000° C./h. In addition, the atmospheric gas was a humidified gas mixture of N₂ and H₂, and the oxygen partial pressure was 10-12 MPa. The annealing conditions were as follows: the heating rate was 200° C./h, the holding temperature was 1050° C., the holding time at the set temperature was 3 hours, the cooling rate was 200° C./h, the atmospheric gas was a humidified N₂ gas, and the oxygen partial pressure was 10⁻⁷ MPa.

The atmospheric gases during firing and annealing were humidified using a humidifier.

Then, end surfaces of the obtained multilayer ceramic fired body were subjected to barrel polishing. The end surfaces that were barrel-polished were then applied with an external electrode paste and subjected to a baking treatment in a reducing atmosphere, thereby obtaining a multilayer ceramic capacitor sample (hereinafter sometimes simply referred to as “capacitor sample”), which was designated as Sample No. 1. The size of the obtained capacitor sample was 2.0 mm×1.2 mm×0.5 mm. The interlayer thickness of the dielectric layers was 1.0 μm, and the thickness of the internal electrode layer was 1.0 μm. The number of the dielectric layers was 100.

The obtained capacitor sample was evaluated for the “complete solid solubility of RE”, the “composition of segregated particles”, and the “occurrence rate of segregated particles”, using the methods described in the above embodiments. The results are shown in Table 1B. The “composition of segregated particles” refers to the composition obtained by defining the total content of Ba in terms of BaO, Si in terms of SiO₂, Ti in terms of TiO₂, and RE in terms of RE₂O₃ in the segregated particles as 100 parts by mol. In addition, the term “n.d.” in the column for the “composition of segregated particles” means that the element was “below the detection limit”, indicating that the segregated particles do not substantially contain RE.

In the obtained capacitor sample, the segregated particles were also present within the main-phase grains, and their average particle size was 50 nm or more and not more than 33% of the average grain size of the main-phase grains.

The obtained capacitor sample was also evaluated for relative permittivity and for high-temperature load life in an accelerated life test, using the following methods. The results are shown in Table 1B.

### (Relative Permittivity)

The capacitance C of the capacitor sample was measured at room temperature (20° C.) by applying a signal with a frequency of 1 kHz and an input signal level (measurement voltage) of 1 Vrms, using a digital LCR meter (Model 4284A, manufactured by YHP). Then, a relative permittivity was calculated based on the thickness of the inner dielectric layers 10, the effective electrode area, and the measured capacitance C.

### (High-Temperature Load Life)

A DC voltage was applied to the capacitor sample under an electric field of 10 V/μm at 180° C. The time from the start of application until the insulation resistance dropped by one digit was defined as a high-temperature load life. This measurement was performed on ten capacitor samples. The maximum (MAX) and minimum (MIN) values of the high-temperature load life were each determined, and the ratio “MAX/MIN” was calculated. The ratio MAX/MIN of the high-temperature load life is an indicator of variation in high-temperature load life among the capacitor samples. That is, the variation in high-temperature load life among the capacitor samples having the same composition and prepared by the same method can be considered small as the ratio MAX/MIN of the high-temperature load life is smaller.

### <Sample No. 5>

After the powder composed of BaᵤTiᵥO₃, which was used as the main component, was wet-mixed using a ball mill to break up agglomerates, some portion of the broken BaᵤTiᵥO₃ powder particles were covered with BaCO₃ powder particles and SiO₂ powder particles in the amounts shown in Table 1A. Except for the above, the experimental conditions according to Sample No. 5 were the same as those in Sample No. 1, and capacitor samples according to Sample No. 5 were obtained and were subjected to the measurements and the tests. The results are shown in Table 1B.

### <Sample Nos. 3, 4, 23, 25, and 22>

The compositions of BaCO₃ and SiO₂ were changed to those shown in Table 1A. Except for the above, the experimental conditions in Sample Nos. 3, 4, 23, 25, and 22 were the same as those in Sample No. 1, and capacitor samples according to Sample Nos. 3, 4, 23, 25, and 22 were obtained and were subjected to the measurements and the tests. The results are shown in Table 1B.

### <Sample Nos. 6, 212, 26, and 24>

The compositions of BaCO₃ and SiO₂ were changed to those shown in Table 2A. Except for the above, the experimental conditions in Sample Nos. 6, 212, 26, and 24 were the same as those in Sample No. 1, and capacitor samples according to Sample Nos. 6, 212, 26, and 24 were obtained and were subjected to the measurements and the tests. The results are shown in Table 2B.

### <Sample Nos. 7, 9, and 10>

The compositions of the subcomponent was changed to that shown in Table 3A. Except for the above, the experimental conditions in Sample Nos. 7, 9, and 10 were the same as those in Sample No. 1, and capacitor samples according to Sample Nos. 7, 9, and 10 were obtained and were subjected to the measurements and the tests. The results are shown in Table 3B.

### <Sample No. 21>

A BaᵤTiᵥO₃ powder having an average particle size of 0.18 μm was used as a main component and that the compositions of the subcomponents were changed to those shown in Table 3A. Except for the above, the experimental conditions in Sample No. 21 were the same as those in Sample No. 1, and capacitor samples according to Sample No. 21 were obtained and were subjected to the measurements and the tests. The results are shown in Table 3B.

### <Sample No. 27>

The following materials were mixed together: the main component detailed below; subcomponents whose compositions were changed to those shown in Table 4A; a glass powder having the composition listed in Table 4A; a Li solution containing Li in the amount specified in Table 4A; and an SiO₂ powder in the amount shown in Table 4A. The mixture, polyvinyl butyral resin, and a solvent mixture of toluene and alcohol were wet-mixed using zirconia balls with a diameter of 1 mm, thereby preparing ceramic slurry. The ceramic slurry was used to obtain a green sheet having a thickness in the range of 0.6 to 2.5 μm by a doctor blade method. Except for the above, the experimental conditions in Sample No. 27 were the same as those in Sample No. 1, and capacitor samples according to Sample No. 27 were obtained and were subjected to the measurements and the tests. The results are shown in Table 4B.

The main component used in Sample No. 27 was a BaᵤTiᵥO₃ powder with an average particle size of 0.2 μm and a u/v ratio of 1.005.

The content of each component in the composition of the glass powder of Sample No. 27 shown in Table 4A is expressed in terms of parts by mol relative to 100 parts by mol of barium titanate, which is the main component.

The content of Li in the Li solution of Sample No. 27 shown in Table 4A is expressed in terms of parts by mol relative to 100 parts by mol of barium titanate, which is the main component.

The content of the SiO₂ powder of Sample No. 27 shown in Table 4A is expressed in terms of parts by mol relative to 100 parts by mol of barium titanate, which is the main component.

### <Sample Nos. 2 and 8>

The type of RE was changed as shown in Table 5A. Except for the above, the experimental conditions in Sample Nos. 2 and 8 were the same as those in Sample No. 1, and capacitor samples according to Sample Nos. 2 and 8 were obtained and were subjected to the measurements and the tests. The results are shown in Table 5B.

### <Sample No. 211>

The heating rate during the firing was changed in accordance with Table 6A. Except for the above, the experimental conditions in Sample No. 211 were the same as those in Sample No. 1, and capacitor samples according to Sample No. 211 were obtained and were subjected to the measurements and the tests. The results are shown in Table 6B.

### <Sample Nos. 11 and 12>

The main component was changed as shown in Table 7A. Except for the above, the experimental conditions in Sample Nos. 11 and 12 were the same as those in Sample No. 1, and capacitor samples according to Sample Nos. 11 and 12 were obtained and were subjected to the measurements and the tests. The results are shown in Table 7B.

In the main component (Ba₁₋ₓSrₓ)ᵤTiᵥO₃ of Sample No. 11, x was 0.05, and the ratio u/v was 1.003.

In the main component Baᵤ(Ti_{1-z}Zr_{z})ᵥO₃ of Sample No. 12, z was 0.06, and the ratio u/v was 1.002.

### <Sample No. 28>

The dielectric raw material was prepared by the following method. Except for the above, the experimental conditions in Sample No. 28 were the same as those in Sample No. 1, and capacitor samples according to Sample No. 28 were obtained and were subjected to the measurements and the tests. The results are shown in Table 8B.

In Sample No. 28, the main component shown in Table 8A was prepared. Then, the powders of BaCO₃, TiO₂, and SiO₂ were weighed in a mole ratio of 9:1:10 and then mixed using a ball mill. The mixture was heat-treated at 1000° C. to obtain a crystalline oxide of Ba—Ti—Si—O. Next, the main component and the crystalline oxide of Ba—Ti—Si—O were weighed in a weight ratio of 98:2 and then mixed using a ball mill to obtain a dielectric raw material.

### <Sample No. 29>

In Sample No. 29, a mixture of BaCO₃, TiO₂, and SiO₂ powders was used instead of the crystalline oxide. The mixture and the main component were weighed in a weight ratio of 98:2 and then mixed using a ball mill to obtain a dielectric raw material. Except for the above, the experimental conditions in Sample No. 29 were the same as those in Sample No. 28, and capacitor samples according to Sample No. 29 were obtained and were subjected to the measurements and the tests. The results are shown in Table 8B.

### <Sample Nos. 210 and 211>

The dielectric raw material was prepared by the following method. Except for the above, the experimental conditions in Sample Nos. 210 and 211 were the same as those in Sample No. 1, and capacitor samples according to Sample Nos. 210 and 211 were obtained and were subjected to the measurements and the tests. The results are shown in Table 8B.

In Sample No. 210, the main component shown in Table 8A was prepared. In addition, raw materials for the additive components shown in Table 8A were also prepared. The contents of the raw materials for the additive components shown in Table 8A are expressed in terms of parts by mol relative to 100 parts by mol of the main component.

Then, powders of BaCO₃, SrCO₃, TiO₂, MnO₂, MgO, and SiO₂ were weighed in a mole ratio of 8.0:1.0:0.5:0.5:0.5:10 and then mixed using a ball mill. The mixture was heat-treated at 900° C. to obtain a crystalline oxide of Ba—Sr—Ti—Mn—Mg—Si—O. Next, the main component, the raw materials for the additive components, and the crystalline oxide of Ba—Sr—Ti—Mn—Mg—Si—O were mixed using a ball mill to obtain a dielectric raw material.

The total amount of the main component, the powders of MgO. RE₂O₃, and SiO₂, and the crystalline oxide of Ba—Sr—Ti—Mn—Mg—Si—O were weighed in a weight ratio of 99.9:0.1.

TABLE 1A

| | | Ba/Si Mol | Compositions of Raw Materials for | | | | | | | |
|---|---|---|---|---|---|---|---|---|---|---|
| | Main | Ratio of Raw | Subcomponents (parts by mol) | | | | | | | Heating |
| Sample | Com- | Materials for | BaCO₃ + | | | | | | | Rate |
| No. | ponent | Subcomponents | SiO₂ | BaCO₃ | SiO₂ | MgO | MnCO₃ | RE₂O₃ | Notes | ° C./h |
| 1 | BaᵤTiᵥO₃ | 6 | 3.50 | 3 | 0.5 | 0.15 | 0.2 | Dy: 0.25 | | 13000 |
| 5 | BaᵤTiᵥO₃ | 6 | 3.50 | 3 | 0.5 | 0.15 | 0.2 | Dy: 0.25 | Coated | 13000 |
| | | | | | | | | | with Ba | |
| | | | | | | | | | and Si | |
| 3 | BaᵤTiᵥO₃ | 6 | 1.75 | 1.5 | 0.25 | 0.15 | 0.2 | Dy: 0.25 | | 13000 |
| 4 | BaᵤTiᵥO₃ | 6 | 5.25 | 4.5 | 0.75 | 0.15 | 0.2 | Dy: 0.25 | | 13000 |
| 23 | BaᵤTiᵥO₃ | 6 | 0.70 | 0.6 | 0.1 | 0.15 | 0.2 | Dy: 0.25 | | 13000 |
| 25 | BaᵤTiᵥO₃ | 6 | 7.00 | 6 | 1 | 0.15 | 0.2 | Dy: 0.25 | | 13000 |
| 22 | BaᵤTiᵥO₃ | 1 | 0.20 | 0.1 | 0.1 | 0.15 | 0.2 | Dy: 0.25 | | 13000 |

TABLE 1B

| | Complete | | | | | Occurrence | | High-Temperature | | |
|---|---|---|---|---|---|---|---|---|---|---|
| | Solid | Composition of Segregated | | | | Rate of | | Load Life | | |
| Sample | Solubility | Particles (parts by mol) | | | | Segregated | Relative | MIN | MAX | MAX/ |
| No. | of RE | Ba | Si | Ti | RE | Particles | Permittivity | (h) | (h) | MIN |
| 1 | 80% | 64.3 | 8.5 | 27.2 | n.d. | 80% | 5400 | 23 | 35 | 2 |
| 5 | 80% | 63.7 | 6.2 | 30.1 | n.d. | 80% | 5400 | 22 | 36 | 2 |
| 3 | 80% | 61.1 | 5.9 | 33.0 | n.d. | 50% | 5600 | 11 | 29 | 3 |
| 4 | 80% | 59.8 | 7.7 | 32.5 | n.d. | 90% | 5300 | 22 | 42 | 2 |
| 23 | 80% | 62.3 | 5.1 | 32.6 | n.d. | 30% | 5400 | 2 | 29 | 15 |
| 25 | 80% | 61.5 | 6.4 | 32.1 | n.d. | 100% | 4400 | 21 | 40 | 2 |
| 22 | 80% | — | — | — | — | 0% | 5500 | 1 | 7 | 7 |

TABLE 2A

| | | Ba/Si Mol Ratio | Compositions of Raw Materials for | | | | | | |
|---|---|---|---|---|---|---|---|---|---|
| | | of Raw | Subcomponents (parts by mol) | | | | | | Heating |
| Sample | Main | Materials for | BaCO₃ + | | | | | | Rate |
| No. | Component | Subcomponents | SiO₂ | BaCO₃ | SiO₂ | MgO | MnCO₃ | RE₂O₃ | ° C./h |
| 1 | BaᵤTiᵥO₃ | 6 | 3.5 | 3 | 0.5 | 0.15 | 0.2 | Dy: 0.25 | 13000 |
| 6 | BaᵤTiᵥO₃ | 3 | 4 | 3 | 1 | 0.15 | 0.2 | Dy: 0.25 | 13000 |
| 212 | BaᵤTiᵥO₃ | 2 | 3 | 2 | 1 | 0.15 | 0.2 | Dy: 0.25 | 13000 |
| 26 | BaᵤTiᵥO₃ | 1 | 2 | 1 | 1 | 0.15 | 0.2 | Dy: 0.25 | 13000 |
| 24 | BaᵤTiᵥO₃ | 10 | 5.5 | 5 | 0.5 | 0.15 | 0.2 | Dy: 0.25 | 13000 |

TABLE 2B

| | Complete | | | | | Occurrence | | High-Temperature | | |
|---|---|---|---|---|---|---|---|---|---|---|
| | Solid | Composition of Segregated | | | | Rate of | | Load Life | | |
| Sample | Solubility | Particles (parts by mol) | | | | Segregated | Relative | MIN | MAX | MAX/ |
| No. | of RE | Ba | Si | Ti | RE | Particles | Permittivity | (h) | (h) | MIN |
| 1 | 80% | 64.3 | 8.5 | 27.2 | n.d. | 80% | 5400 | 23 | 35 | 2 |
| 6 | 80% | 63.9 | 9.6 | 26.5 | n.d. | 70% | 5400 | 19 | 34 | 2 |
| 212 | 80% | 58.2 | 10.4 | 30.5 | 0.9 | 80% | 5500 | 1 | 9 | 9 |
| 26 | 80% | 69.2 | 14.7 | 15.1 | 1 | 80% | 5600 | 2 | 9 | 5 |
| 24 | 80% | 58.3 | 7.3 | 34.4 | n.d. | 100% | 4500 | 22 | 37 | 2 |

TABLE 3A

| | | Compositions of Raw Materials for | | | | | | Heating |
|---|---|---|---|---|---|---|---|---|
| Sample | Main | Subcomponents (parts by mol) | | | | | | Rate |
| No. | Component | BaCO₃ | SiO₂ | MgO | MnCO₃ | V₂O₅ | RE₂O₃ | ° C./h |
| 1 | BaᵤTiᵥO₃ | 3 | 0.5 | 0.15 | 0.2 | 0 | Dy: 0.25 | 13000 |
| 7 | BaᵤTiᵥO₃ | 3 | 0.5 | 0.3 | 0.2 | 0 | Dy: 0.25 | 13000 |
| 9 | BaᵤTiᵥO₃ | 3 | 0.5 | 0.05 | 0.2 | 0 | Dy: 0.25 | 13000 |
| 10 | BaᵤTiᵥO₃ | 3 | 0.5 | 0.5 | 0.2 | 0 | Dy: 0.25 | 13000 |
| 21 | BaᵤTiᵥO₃ | 0.5 | 1 | 1 | 0.2 | 0.05 | Ho: 0.4 | 13000 |
| | | | | | | | Yb: 0.2 | |
| | | | | | | | Dy: 1.1 | |

TABLE 3B

| | Complete | | | | | Occurrence | | High-Temperature | | |
|---|---|---|---|---|---|---|---|---|---|---|
| | Solid | Composition of Segregated | | | | Rate of | | Load Life | | |
| Sample | Solubility | Particles (parts by mol) | | | | Segregated | Relative | MIN | MAX | MAX/ |
| No. | of RE | Ba | Si | Ti | RE | Particles | Permittivity | (h) | (h) | MIN |
| 1 | 80% | 64.3 | 8.5 | 27.2 | n.d. | 80% | 5400 | 23 | 35 | 2 |
| 7 | 70% | 59.3 | 6.2 | 34.5 | n.d. | 80% | 5100 | 25 | 37 | 1 |
| 9 | 100% | 60.7 | 9.1 | 30.2 | n.d. | 80% | 5700 | 19 | 30 | 2 |
| 10 | 70% | 56.5 | 3.6 | 39.9 | n.d. | 80% | 5000 | 32 | 46 | 1 |
| 21 | 60% | 36.1 | 21.2 | 32.6 | 10 | 100% | 2517 | 80 | 92 | 1 |

TABLE 4A

| | | | | | | | | | | Li | | |
|---|---|---|---|---|---|---|---|---|---|---|---|---|
| | | | | | | | | | | Content | | |
| | | | | | | | | | | in Li | Content | |
| | | | | | | | | | | Solution | of SiO₂ | |
| | | Compositions of Raw Materials | | | | Composition of Glass Powder | | | | (parts | Powder | Heating |
| Sample | Main | for Subcomponents (parts by mol) | | | | (parts by mol) | | | | by mol) | (parts | Rate |
| No. | Component | V₂O₅ | RE₂O₃ | MgO | MnCO₃ | SiO₂ | BaO | CaO | Li₂O | Li₂O | by mol) | ° C./h |
| 27 | BaᵤTiᵥO₃ | 0.05 | Y: 0.5 | 1 | 0.4 | 0.6 | 0.48 | 0.48 | 0.24 | 0.96 | 0.6 | 13000 |

TABLE 4B

| | Complete | | | | | Occurrence | | High-Temperature | | |
|---|---|---|---|---|---|---|---|---|---|---|
| | Solid | Composition of Segregated | | | | Rate of | | Load Life | | |
| Sample | Solubility | Particles (parts by mol) | | | | Segregated | Relative | MIN | MAX | MAX/ |
| No. | of RE | Ba | Si | Ti | RE | Particles | Permittivity | (h) | (h) | MIN |
| 27 | 0% | 8.7 | 80.7 | 10.6 | n.d. | 40% | 3800 | 1 | 52 | 52 |

TABLE 5A

| Sam- | | Compositions of Raw Materials for | | | | | Heating |
|---|---|---|---|---|---|---|---|
| ple | Main | Subcomponents (parts by mol) | | | | | Rate |
| No. | Component | BaCO₃ | SiO₂ | MgO | MnCO₃ | RE₂O₃ | ° C./h |
| 1 | BaᵤTiᵥO₃ | 3 | 0.5 | 0.15 | 0.2 | Dy: | 13000 |
| | | | | | | 0.25 | |
| 2 | BaᵤTiᵥO₃ | 3 | 0.5 | 0.15 | 0.2 | Y: 0.25 | 13000 |
| 8 | BaᵤTiᵥO₃ | 3 | 0.5 | 0.15 | 0.2 | Gd: | 13000 |
| | | | | | | 0.25 | |

TABLE 5B

| | Complete | | | | | Occurrence | | High-Temperature | | |
|---|---|---|---|---|---|---|---|---|---|---|
| | Solid | Composition of Segregated | | | | Rate of | | Load Life | | |
| Sample | Solubility | Particles (parts by mol) | | | | Segregated | Relative | MIN | MAX | MAX/ |
| No. | of RE | Ba | Si | Ti | RE | Particles | Permittivity | (h) | (h) | MIN |
| 1 | 80% | 64.3 | 8.5 | 27.2 | n.d. | 80% | 5400 | 23 | 35 | 2 |
| 2 | 70% | 63.2 | 8.8 | 28 | n.d. | 80% | 5400 | 20 | 32 | 2 |
| 8 | 100% | 62.3 | 9.4 | 28.3 | n.d. | 80% | 5800 | 16 | 24 | 2 |

TABLE 6A

| Sam- | | Compositions of Raw Materials for | | | | | Heating |
|---|---|---|---|---|---|---|---|
| ple | Main | Subcomponents (parts by mol) | | | | | Rate |
| No. | Component | BaCO₃ | SiO₂ | MgO | MnCO₃ | RE₂O₃ | ° C./h |
| 1 | BaᵤTiᵥO₃ | 3 | 0.5 | 0.15 | 0.2 | Dy: | 13000 |
| | | | | | | 0.25 | |
| 211 | BaᵤTiᵥO₃ | 3 | 0.5 | 0.15 | 0.2 | Dy: | 200 |
| | | | | | | 0.25 | |

TABLE 6B

| | Complete | | | | | Occurrence | | High-Temperature | | |
|---|---|---|---|---|---|---|---|---|---|---|
| | Solid | Composition of Segregated | | | | Rate of | | Load Life | | |
| Sample | Solubility | Particles (parts by mol) | | | | Segregated | Relative | MIN | MAX | MAX/ |
| No. | of RE | Ba | Si | Ti | RE | Particles | Permittivity | (h) | (h) | MIN |
| 1 | 80% | 64.3 | 8.5 | 27.2 | n.d. | 80% | 5400 | 23 | 35 | 2 |
| 211 | 80% | 41.8 | 19.1 | 39.1 | n.d. | 20% | 5400 | 1 | 29 | 29 |

TABLE 7A

| | | Compositions of Raw Materials for | | | | | Heating |
|---|---|---|---|---|---|---|---|
| Sample | | Subcomponents (parts by mol) | | | | | Rate |
| No. | Main Component | BaCO₃ | SiO₂ | MgO | MnCO₃ | RE₂O₃ | ° C./h |
| 1 | BaᵤTiᵥO₃ | 3 | 0.5 | 0.15 | 0.2 | Dy: 0.25 | 13000 |
| 11 | (Ba₁₋ₓSrₓ)ᵤTiᵥO₃ | 3 | 0.5 | 0.15 | 0.2 | Dy: 0.25 | 13000 |
| 12 | Baᵤ(Ti_{1-z}Zr_{z})ᵥO₃ | 3 | 0.5 | 0.15 | 0.2 | Dy: 0.25 | 13000 |

TABLE 7B

| | Complete | | | | | Occurrence | | High-Temperature | | |
|---|---|---|---|---|---|---|---|---|---|---|
| | Solid | Composition of Segregated | | | | Rate of | | Load Life | | |
| Sample | Solubility | Particles (parts by mol) | | | | Segregated | Relative | MIN | MAX | MAX/ |
| No. | of RE | Ba | Si | Ti | RE | Particles | Permittivity | (h) | (h) | MIN |
| 1 | 80% | 64.3 | 8.5 | 27.2 | n.d. | 80% | 5400 | 23 | 35 | 2 |
| 11 | 80% | 53.4 | 6.6 | 40 | n.d. | 80% | 5600 | 27 | 33 | 1 |
| 12 | 70% | 68.3 | 9.9 | 21.8 | n.d. | 80% | 5400 | 24 | 35 | 1 |

TABLE 8A

| | | Composition of | Compositions of Raw Naterials for Additive | | | | | Heating |
|---|---|---|---|---|---|---|---|---|
| Sample | | Crystalline Oxide | Component (parts by mol) | | | | | Rate |
| No. | Main Component | (parts by mol) | BaCO₃ | TiO₂ | SiO₂ | MgO | RE₂O₃ | ° C./h |
| 28 | (Ba_{0.93}Ca_{0.07})TiO₃ | Ba:Si:Ti = | 0 | 0 | 0 | 0 | 0 | 13000 |
| | | 9:10:1 | | | | | | |
| 29 | (Ba_{0.93}Ca_{0.07})TiO₃ | | 1.69 | 0.19 | 1.88 | 0 | 0 | 13000 |
| 210 | (Ba_{0.98}Ca_{0.02})(Ti_{0.995}Zr_{0.005})O₃ | Ba:Sr:Ti:Mn:Mg:Si = | 0 | 0 | 2 | 0 | Dy: 1.0 | 13000 |
| | | 8:1:0.5:0.5:0.5:10 | | | | | | |
| 211 | (Ba_{0.98}Ca_{0.02})(Ti_{0.995}Zr_{0.005})O₃ | Ba:Sr:Ti:Mn:Mg:Si = | 0 | 0 | 2 | 1 | Sm: 1.0 | 13000 |
| | | 8:1:0.5:0.5:0.5:10 | | | | | | |

TABLE 8B

| | Complete | | | | | Occurrence | | High-Temperature | | |
|---|---|---|---|---|---|---|---|---|---|---|
| | Solid | Composition of Segregated | | | | Rate of | | Load Life | | |
| Sample | Solubility | Particles (parts by mol) | | | | Segregated | Relative | MIN | MAX | MAX/ |
| No. | of RE | Ba | Si | Ti | RE | Particles | Permittivity | (h) | (h) | MIN |
| 28 | 0% | 44.8 | 50.2 | 5 | n.d. | 30% | 3900 | 2 | 12 | 6 |
| 29 | 0% | 44.9 | 50 | 5.1 | n.d. | 40% | 4300 | 1 | 9 | 9 |
| 210 | 90% | — | — | — | — | 0% | 4100 | 1 | 5 | 5 |
| 211 | 20% | — | — | — | — | 0% | 3700 | 1 | 8 | 8 |

As shown in Tables 1A and 1B, compared with the samples in which the occurrence rate of the segregated particles was 30% or less (Sample Nos. 23 and 22), the samples in which the occurrence rate of the segregated particles was in the range of 50 to 90% (Sample Nos. 1, 5, 3, and 4) exhibited a larger minimum value (MIN) and a smaller MAX/MIN ratio in terms of the high-temperature load life. Thus, the samples in which the occurrence rate of the segregated particles was in the range of 50 to 90% had improved high-temperature load life, and variation in the high-temperature load life among the capacitor samples was reduced. As a result, the samples exhibited excellent long service life.

As shown in Tables 1A and 1B, compared with the sample in which the occurrence rate of the segregated particles was 100% (Sample No. 25), the samples in which the occurrence rate of the segregated particles was in the range of 50 to 90% (Sample Nos. 1, 5, 3, and 4) exhibited a higher relative permittivity.

As shown in Tables 2A and 2B, compared with the samples in which the segregated particles contained 0.9 mol % or more of RE (Sample Nos. 212 and 26), the samples in which RE was substantially absent from the segregated particles (Sample Nos. 1 and 6) exhibited a larger minimum value (MIN) and a smaller MAX/MIN ratio in terms of the high-temperature load life.

As shown in Tables 3A and 3B, compared with the sample in which the complete solid solubility of RE was 60% (Sample No. 21), the samples in which the complete solid solubility of RE was 70% or more (Sample Nos. 1, 7, 9, and 10) exhibited a higher relative permittivity.

As shown in Tables 4A and 4B, Sample No. 27 exhibited the following characteristics: the complete solid solubility of RE was 0%; the occurrence rate of the segregated particles was 40%; the relative permittivity was 3800; the minimum (MIN) of the high-temperature load life was 1; and the MAX/MIN ratio was 52. In addition, agglomeration of the segregated particles was observed in Sample No. 27.

As shown in Tables 7A and 7B, each of the samples (Sample Nos. 1, 11, and 12) exhibited an excellent long service life and a high permittivity. In these samples, the main component is represented by the formula ABO₃, in which the symbol A represents at least one selected from the group consisting of Ba, Ca, and Sr, and the symbol B represents at least one selected from the group consisting of Ti and Zr.

As shown in Tables 8A and 8B, the occurrence rate of the segregated particles was 0% in each of Sample Nos. 210 and 211. The reason for this is considered to be that the added crystalline oxide particles prevented the segregated particles from dispersing uniformly, resulting in their uneven distribution.

### DESCRIPTION OF THE REFERENCE NUMERALS

2 . . . multilayer ceramic capacitor
   4 . . . element body
      10 . . . inner dielectric layer
         10a . . . main-phase grain (dielectric grain)
         10b . . . segregated particle
      11 . . . outer dielectric layer
      12 . . . internal electrode layer
      13 . . . effective region
   6 . . . external electrode

What is claimed is:

1. An electronic component comprising:
an element body including internal electrode layers and dielectric layers substantially parallel to a plane including a first axis and a second axis and alternately laminated along a third axis,
wherein
the element body has a pair of end surfaces opposing each other in the first axis direction, each of the end surfaces is provided with an external electrode electrically connected to the internal electrode layers,
the dielectric layers contain main-phase grains and segregated particles,
the main-phase grains contain a main component of the dielectric layers,
the main component is represented by a formula ABO₃, in which the symbol A represents at least one selected from the group consisting of Ba, Ca, and Sr, and the symbol B represents at least one selected from the group consisting of Ti and Zr,
the segregated particles contain Ba, Si, Ti, and O,
the segregated particles are present at an occurrence rate in the range of 50 to 90%,
the occurrence rate of the segregated particles is defined as a ratio of the number of fields of view satisfying conditions
(i) eight or more of the segregated particles are present, and
(ii) at least one segregated particle is located at a triple junction,
among a predetermined number of fields of view in which four or more of the dielectric layers are observed, in a cross section parallel to a plane including the first axis and the second axis of an effective region, the effective region is a region where the dielectric layers are laminated between pairs of internal electrode layers having different polarities,
the fields of view to be observed are approximately uniformly distributed along the first axis direction, the second axis direction, and the third axis direction of the effective region,
a ratio of the main-phase grains in the form of complete solid solutions containing RE is 70% or more of the main-phase grains,
the segregated particles do not substantially contain RE, and
the RE represents at least one of rare earth elements.

2. The electronic component according to claim 1, wherein
at least one of the segregated particles is present within one of the main-phase grains.

3. The electronic component according to claim 1, wherein
the content of Ba in terms of BaO in the segregated particles is 50 parts by mol or more, assuming that the total content of Ba in terms of BaO, Si in terms of SiO₂, Ti in terms of TiO₂, and RE in terms of RE₂O₃ in the segregated particles is defined as 100 parts by mol.

4. The electronic component according to claim 1, wherein
the content of Si in terms of SiO₂ in the segregated particles is 10 parts by mol or less, assuming that the total content of Ba in terms of BaO, Si in terms of SiO₂, Ti in terms of TiO₂, and RE in terms of RE₂O₃ in the segregated particles is defined as 100 parts by mol.

5. The electronic component according to claim 1, wherein
the content of Ti in terms of TiO₂ in the segregated particles is 40 parts by mol or less, assuming that the total content of Ba in terms of BaO, Si in terms of SiO₂, Ti in terms of TiO₂, and RE in terms of RE₂O₃ in the segregated particles is defined as 100 parts by mol.

6. The electronic component according to claim 1, wherein
the average particle size of the segregated particles is 50 nm or more.

7. The electronic component according to claim 1, wherein
the average particle size of the segregated particles is 33% or less of the average grain size of the main-phase grains.
